(19) United States
(12) Patent Application Publication
(10) Pub. No.: US 2026/0340419 A1
(43) Pub. Date: Oct. 29, 2026

(54) DYNAMICALLY ADJUSTING USER INTERFACE ELEMENT ENABLED BY AGENTIC AND GENERATIVE ARTIFICIAL INTELLIGENCE

(71) Applicant: International Business Machines Corporation, Armonk, NY (US)

(72) Inventors: Jennifer M. HATFIELD, Portland, OR (US); Stacy DOYLE, Whitby (CA); Aaron BAUGHMAN, Cary, NC (US)

(21) Appl. No.: 19/189,741

(22) Filed: Apr. 25, 2025

(51) Int. Cl. G06N 3/10

(52) U.S. Cl. CPC G06N 3/10

(57) ABSTRACT

A computer-implemented method, for contextual nudging, comprising: identifying a user type of a user using one or more tools; identifying one or more insights relevant to the user type based on data received from the one or more tools; determining a most likely action path the user will take using Bayesian statistics; determining a nudge based on user context, wherein the user context is based on the data; determining a section, on a user interface provided by a computing device, for presenting the nudge; presenting the nudge in the section of the user interface; and monitoring actions of the user within the user interface and determining an effectiveness of the nudge. The data is obtained by the one or more tools from datastores. The most likely action path is determined based on the data. The section is determined based on the most likely action path and the user context.

### BACKGROUND

The present invention relates to a user interface element of a user interface for intelligent workflows, and for example, relates to dynamically adjusting the user interface element based on information regarding a user of the user interface.

A computing device includes a machine that performs various operations, such as receiving data, storing data, and processing data to output results. In some situations, the computing device may execute an application. As a result of executing the application, a graphical user interface may be generated and provided via a display of the computing device. The graphical user interface may include graphical user interface elements.

### SUMMARY

A computer-implemented method for contextual nudging, the computer-implemented method comprising: identifying a user type of a user using one or more tools, wherein the one or more tools are connected to datastores; identifying one or more insights relevant to the user type based on data received from the one or more tools, wherein the data is obtained by the one or more tools from the datastores; determining a most likely action path the user will take using Bayesian statistics, wherein the most likely action path is determined based on the data; determining a nudge based on user context, wherein the user context is based on the data; determining a section, on a user interface provided by a computing device, for presenting the nudge, wherein the section is determined based on the most likely action path and the user context; presenting the nudge in the section of the user interface; and monitoring actions of the user within the user interface and determining an effectiveness of the nudge.

A computer program product comprising: one or more computer-readable storage media; and program instructions stored on the one or more computer readable storage media to perform operations comprising: identifying a user type, of a user, using one or more tools; identifying one or more insights relevant to the user type based on data received from the one or more tools, wherein the data is obtained by the one or more tools from datastores; determining a most likely action path a user will take while using an application executed by a computing device of the user, wherein the most likely action path is determined using user data included in the data and statistical data, and wherein the user data indicates actions that have been performed by the user using the application; determining a user interface element based on user context of the user, wherein the user interface element provides information regarding the one or more insights, and wherein the user context is based on the data; determining a type of the user interface element based on the user data, wherein the user data indicates actions performed by the user with respect to one or more types of user interface elements; and presenting the user interface element, of the determined type, on a user interface of the application.

A computer system comprising: one or more computer-readable storage media; a processor set; and program instructions stored on the one or more computer-readable storage media to cause the processor set to perform operations comprising: identifying a user type, of a user, using one or more tools; identifying one or more insights relevant to the user type based on data received from the one or more tools, wherein the data is obtained by the one or more tools from datastores; determining a most likely action path a user will take while using an application executed by a computing device of the user, wherein the most likely action path is determined using user data included in the data and statistical data, and wherein the user data indicates actions that have been performed by the user using the application; determining a user interface element based on user context of the user, wherein the user interface element provides information regarding the one or more insights, and wherein the user context is based on the data; determining a type of the user interface element based on the user data, wherein the user data indicates actions performed by the user with respect to one or more types of user interface elements; and presenting the user interface element, of the determined type, on a user interface of the application.

### BRIEF DESCRIPTION OF THE DRAWINGS

FIGS. 1A and 1B illustrates a block diagram of a computing environment described herein.

FIGS. 2A-2D are diagrams of an example implementation described herein.

FIG. 3 is a diagram of an example computing environment in which systems and/or methods described herein may be implemented.

FIG. 4 is a diagram of example components of one or more devices of FIGS. 1A and 1B.

FIGS. 5A and 5B are flowcharts of an example process associated with managing duplication or conflicts during computer system configuration.

FIG. 6 is a flowchart of an example process associated with managing duplication or conflicts during computer system configuration.

### DETAILED DESCRIPTION

The following detailed description of example implementations refers to the accompanying drawings. The same reference numbers in different drawings may identify the same or similar elements.

An application may be executed by a computing device. As a result of executing the application, a graphical user interface may be presented on a display of the computing device. A graphical user interface element may be provided on the graphical user interface. The graphical user interface element may be used to interact with the application. For example, the graphical user interface element may be used to access and complete a training for using the application.

Generating and presenting the graphical user interface element consumes computational resources. For example, in some situations, the computing device may perform graphical redraws to update content of the graphic user interface. In some situations, the computing device may perform a screen refresh at different rates to redraw an image that is included in the graphical user interface. Generating and presenting the graphical user interface element consumes computational resources.

In some situations, the graphical user interface element may be used less frequently by a user than expected. In fact, in some situations, the graphical user interface element may not be at all. In some situations, the graphical user interface element may be used less frequently or not used at all because the graphical user interface element may be of a type that does not elicit user interaction of the user. In some situations, the graphical user interface element may be used less frequently or not used at all because the graphical user interface element may be provided in a section (of the graphical user interface) that is overlooked by the user.

The graphical user interface element may be used to perform a task of the application. By less frequently using the graphical user interface element or by not using the graphical user interface element at all, the user may fail to perform a task that may enhance an experience of the user with respect to the application, that may improve a level of expertise of the user with respect to using the application, or that may improve a measure of productivity for another task, among other examples.

In this regard, existing graphical user interfaces do not enhance user engagement, adoption, and satisfaction across various user types (e.g., prospective, intermediate, and expert users) within a platform. Currently, users may struggle to navigate applications or platforms, complete tasks efficiently, or fully utilize features due to a lack of personalized guidance. This can lead to decreased user satisfaction, reduced productivity, among other examples.

Based on foregoing, because the graphical user interface element is less frequently used or not used at all, generating and presenting the graphical user interface that includes the graphical user interface element wastes computational resources of the computing device. Accordingly, a need exists to address the technical problem of wasting computing resources to generate and present a graphical user interface element in a manner that causes the element to be used. For example, a need exists to generate and present a graphical user interface with a graphical user interface element that will improve the amount of computing resources consumed.

Implementations described herein are directed to improving (e.g., not wasting) computing resources usage of a computing device by generating and presenting a user interface element of a user interface of an application. The user interface may be a graphical user interface. The user interface element may be an element or component of the user interface. The user interface element may include a graphical user interface element as well as text and/or sound (e.g., audio). In some examples, implementations described herein are directed to a sophisticated system that can understand and adapt to users' unique contexts, behaviors, and needs. This system may provide subtle, timely, and personalized content (also referred to as a “nudge” or a “contextual nudge”) to help users make better decisions, complete tasks more efficiently, and ultimately derive more value from an application (e.g., a software platform). The content may include textual content, image/graphical content, and/or audio content. In other words, the nudge may be of a different type (e.g., text, image, audio). In some examples, the nudge (or the content) may be in the form of a user interface element of a graphical user interface of the application. Implementations described herein may enable a user to be guided for more value and benefit of usage from the application.

In some examples, a nudge (or contextual nudge) may adapt to meet the needs of the user based on information identifying the user (e.g., a type of the user) and based on actions to be performed by the user via the application (e.g., a path that the user may follow to perform the actions). The type of the user may include a prospective user of the application, a new user of the application, or an experienced user of the application. In other words, the type of the user may indication a level of experience with respect to using the application. Implementations described herein may support the ability to guide the user, support and motivate the user based on past actions of the user, based on data, based on historical actions typical of other users of a same type, and prediction of where the user will be going next (e.g., where the user will navigate to in the application) and the actions the user will take to get there.

A nudge (or contextual nudge) may include a type of subliminal influence that can be used to guide the user towards certain actions or decisions in the user interface. The nudge may be based on behavioral economics principles, such as the availability heuristic, which suggests that people are more likely to choose options that are readily available. For example, placing a frequently used user interface element in a prominent location on the user interface can nudge users towards interacting with the user interface element (e.g., clicking it) without the user having to think about it.

In the context of generative artificial intelligence (“GenAI”), a nudge may be used to guide the user towards certain actions or decisions. For example, a chatbot can use contextual n-grams to understand a current context of the user and provide relevant suggestions or prompts for the user.

Implementations described herein incorporate a system to reinforce good behaviors tied to task initiation and completion when using the application versus negative behaviors, such as no action taken when using the application. A network of platforms, products, and applications can all be connected according to determined group of users based that could be driven by a long term strategy behind culling specific behaviors or actions to a particular goal or outcome. In this regard, the AI model is not limited to a single product but may span multiple platforms and products that a user may navigate within a specified system. For example, implementations described herein are applicable to a network of multiple platforms, with each platform having different products. In this regard, nudges may be orchestrated to nudge the user based on their last action taken within the network in a first product, that would inform a nudge the user would receive in a second product.

Implementations described herein are directed to a novel technical solution that includes a system designed to elevate user engagement and seamlessly guide the user through various stages of interaction with an application or platform. This system may be tailored to meet the unique needs and behaviors of new, intermediate, and experienced users, ensuring a personalized and intuitive experience for all users.

Additionally, the system may tie into intelligent workflows and ways a user can most effectively and efficiently optimize task completion. It also views intelligent workflows at a team level and orchestrates team efficiency by optimizing AI and automation while bringing the best team member into the loop to inform and drive success. In some examples, the nudges may be tied to specific workflows or processes, so that a user could be nudged at a specific step in the process that needs their input or action taken. The nudge may also be triggered based on a dependency for the process to move forward based on user input of the user. This could operate at a team level (of multiple users) where a first user may have a specie knowledge or input that they need to provide at a third step of a workflow whereas a second user may need to provide input at a sixth step 6 based on their knowledge or skill set.

In some implementations, the technical solution may include performing (graphical) operations on the user interface to draw the attention of the user to the user interface element, thereby causing the user to interact with the user interface element or thereby increasing a likelihood of the user interacting with the user interface element. For example, the system may detect a particular section of the user interface that include the user interface element and may maintain a screen refresh rate of the particular section and may reduce a screen refresh rate of a remaining section of the user interface. By maintaining the screen refresh rate of the particular section and reducing the screen refresh rate of the remaining section, the system may draw the attention of the user to the particular section and the user interface element.

By maintaining the screen refresh rate of the particular section and reducing the screen refresh rate of the remaining section, the system may preserve computing resources that would have been used to maintain the screen refresh rate on an entirety of the user interface. In a manner similar to the manner described with respect to the screen refresh rate, the system may maintain a screen redraw (rate) of the particular section and reduce the screen redraw (rate) of the remaining section. The system may perform other (graphical) operations on the user interface to draw the attention of the user to the particular section and the user interface element. Additionally, or alternatively, the technical solution may include determining a type of nudge based on information the type of the user, information regarding actions that have been performed by the user, information regarding actions that have been performed by other users of the same type, among other examples. The type of nudge may include text, an image, graphics (e.g., an overlay), audio, among other examples.

The information regarding the actions may include information identifying different types of user interface elements, different locations of the user interface elements on the user interface, an amount of interactions from the different types of users and for the different locations of the user interface elements, actions that lead to the interaction (e.g., a most likely action path the user took prior to interacting with the user interface elements).

In some implementations, the technical solution may include causing the user interface element to dynamically change based on information regarding the user. For example, the user interface element may dynamically change as the level of experience changes (e.g., as the user transitions from a new user to an experienced user). For example, a shape and/or a color of the user interface element may change. As an another examples, a type of the user interface element may change based on the level of experience of the user. In some implementations, the user interface element may dynamically change as the level of experience changes.

In some implementations, the user interface element may dynamically change as the user (and/or other users of the same type) changes their interactions with different types of user interface elements. For example, if the system detects that the user is increasingly interacting with a user interface element of a first type and decreasingly interacting with a user interface element of a second type, the system may present a user interface element of the first type.

In some implementations, the technical solution may include determining when to present the user interface element. For example, the system may determine what actions the user has performed and determine an action that the user may perform. Based on determining the action that the user may perform, the system may provide the user interface element. For example, the user interface element may be provided to guide the user to perform the action. In some examples, the system may detect an event and provide the user interface element based on detecting the event. For example, the system may detect a resource usage that satisfies a usage threshold and provide the user interface element. For instance, the system may detect a memory usage that satisfies a usage threshold and may provide a nudge to deploy an AI agent that monitors memory usage. The system may perform similar actions with respect to usage of other resources of one or more computing devices. Based on the foregoing, implementations described herein may solve the technical problems described above.

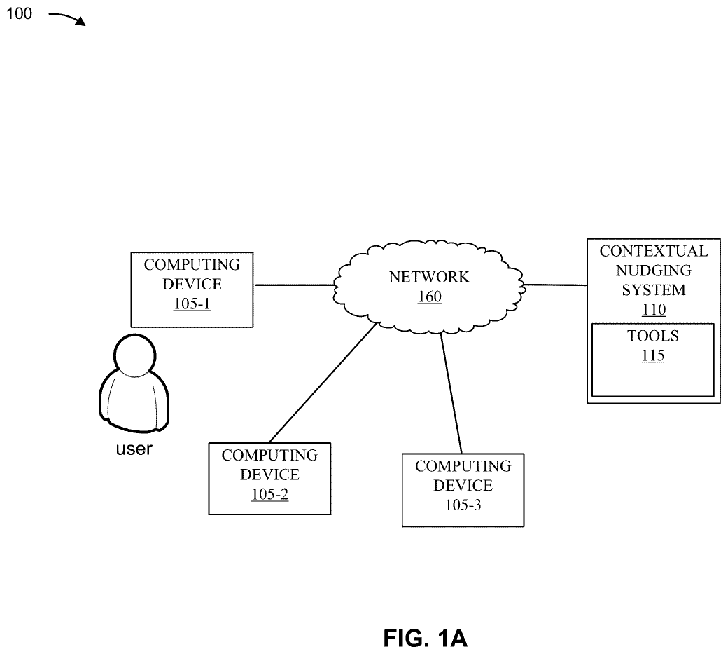

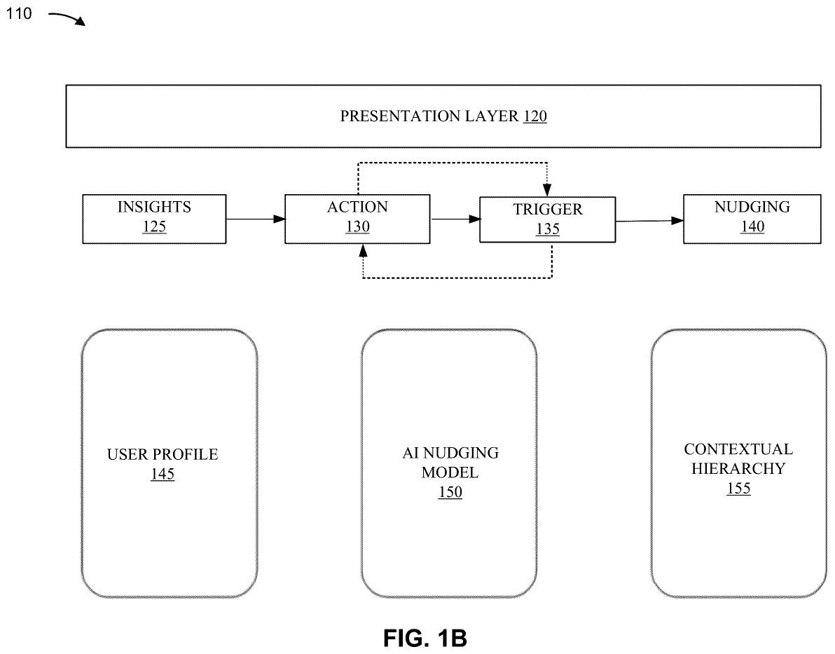

FIGS. 1A and 1B illustrates block diagrams of a computing environment 100 for reducing computing resource usage by dynamically adjusting a type and/or a location of the user interface element based on information regarding a user of the user interface. The computing environment 100 includes a first computing device 105-1, a second computing device 105-2, a third computing device 105-3, and so on (collectively “computing devices 105” and individually “computing device 105”), and a contextual nudging system 110. In some implementations, the computing devices 105 and the contextual nudging system 110 may be connected via network 160. In some implementations, the contextual nudging system 110 may include one or more computing devices 105. In some implementations, the contextual nudging system 110 may be implemented on a computing device 105.

The computing device 105 may encompass a wide range of computing systems and architectures. In some aspects, the computing device 105 may be part of a cloud computing infrastructure, which may include public, private, or hybrid cloud environments. Cloud computing devices may include virtualized resources, such as virtual machines or containers, running on physical hardware in data centers. In some implementations, the computing device 105 may be based on mainframe architectures. These systems may be designed for high-volume transaction processing and may include features like redundant components for high availability and reliability. Mainframe systems may be particularly suited for handling large-scale error management tasks due to their robust error detection and recovery capabilities.

The computing device 105 may include a distributed system, such as those based on microservices architectures. In these systems, applications may be broken down into smaller, independent services that communicate over a network. In some implementations, the computing device 105 may be an edge computing node, which process data closer to the source of data generation. In some implementations, the computing device 105 may include a computer, a mobile device, such as smartphones or tablet, among other examples. The computer device 105 may be operated by a user. In some examples, the computer device 105 may be executing an application and, as a result, a user interface may be presented on a display of the computer device 105. The user may use the computing device to navigate different portions of the application (e.g., different locations).

The contextual nudging system 110 may include one or more computing devices that dynamically adjust a type of a nudge (e.g., a user interface element) and/or dynamically adjust a location of the nudge based on information regarding a user of the user interface. The contextual nudging system 110 may intelligently classify or categorize users into three types: prospective users, new users, and experienced users. This classification may enable the delivery of nudges that are precisely tailored to a level of experience of the user (e.g., a level of familiarity) with the application or the platform.

The contextual nudging system 110 may generate and present nudges (or contextual nudges) which are subtle influences that guide users towards specific actions or decisions within the user interface. The contextual nudging system 110 may determine rules for how the nudge operates based on a contextual experience. Contextuality may be determined by intention, position in the product structure, past behaviors of users (e.g., past interactions of users with nudges), alerts, events, primary task flows and prioritization based on preference or prioritization based on event driven episodes.

The contextual nudging system 110 may perform scoring of activities based on a task that is pending, a task that is in progress, a task that has been completed, a measure of success with respect to completing a task, a speed of completion and discovery (such as completing the education, exploring the prompts, etc.). The contextual nudging system 110 may assess the user's receptivity to different types of nudges and adjusts the nudges accordingly to maintain effectiveness and motivation. For example, if the contextual nudging system 110 detects a receptivity to a first type of nudge exceeds a receptivity to a second type of nudge, the contextual nudging system 110 may present the first type of nudge. The receptivity may be determined based on interactions of the user and/or interactions of other users of a same (or similar) type.

The contextual nudging system 110 may enable the nudges to extend beyond the application to various devices and environments where users may need reminders or alerts. The various devices and environment may include mobile devices, augmented reality/virtual reality (AR/VR) interfaces, and speech-based systems. For example, a nudge may be presented on a first computing device of the user (e.g., a laptop) and/or also presented on a second computing device of the user (e.g., a mobile device).

The contextual nudging system 110 may identify key tasks to set the user up for what the user need to do, tasks the user needs to perform, and who the user needs to connect with for completion and team success. As an example, the contextual nudging system 110 may determine priorities of a plurality of tasks, of the application, to be performed by the user and may present the user interface element based on a priority of a task of the plurality of tasks. The user interface element is associated with a task of the plurality of tasks. In some examples, the plurality of tasks may be prioritized based on one or more preferences of the user.

In some examples, category/type/class may be able to map to contextual situations more extensively through quick inputs during the life of a single session while mapping to a long-term interaction with a user with the capability of historical memory, insights, and constant evolution. Additionally, the contextual nudging system 110 may ty into intelligent workflows through agentic AI and ways a user can most effectively and efficiently optimize task completion. It also views intelligent workflows at a team level and orchestrates team efficiency by optimizing AI and automation while bringing the best team member into the loop to inform and drive success. In some examples, the system memory may bring long term optimization not just by graphical user interface nudges, but learning over time how a user engages and provides inputs with the system. For example, the system may determine that a first user is more responsive and provide more accurate inputs than a second user. Accordingly, the system will adjust to know to solicit input from the first user for specific items instead soliciting input from the second user.

As shown in FIG. 1A, the contextual nudging system 110 may include one or more tools 115. In some implementations, the one or more tools 115 may be used to access data from datastores that user information regarding users and images of user interfaces. The data may be used to determine a context associated with a user interface and to determine a nudge (e.g., a user interface element) to be presented with the user interface.

As shown in FIG. 1B, the contextual nudging system 110 may implement a contextual nudge foundation framework. As shown in FIG. 1B, the contextual nudge foundation framework may include a presentation layer 120, an insights component 125, an action component 130, a trigger component 135, and a nudging component 140. The presentation layer 120 may include interact directly with the user. For example, the presentation layer 120 may present nudges to the user. Additionally, or alternatively, the presentation layer 120 may categorize or classify the user based on the level of experience of the user. As an example, if the presentation layer 120 determines that no user information exists regarding the user or that the user information exists but the amount of information not does not satisfy a threshold, the presentation layer 120 may determine that the user is a prospective user. The presentation layer 120 may determine that the user is a new user based on the user information indicating the number of tasks completed by the user does not satisfy a number threshold. The presentation layer 120 may determine that the user is an experience based on the user information indicating the number of tasks satisfies the number threshold.

The insights component 125 may collect data and insights about user behavior and preferences of the user and may provide (or feed) the data and insights to the action component 130. The action component 130 may determine an appropriate action based on the insights gathered and may trigger a next step.

The trigger component 135 may initiate the nudge based on the determined action, ensuring the nudge is contextually appropriate and timely. The nudge may be contextually appropriate and timely if the nudge relates to the determined action or if the nudge is based on a detected event. For example, the nudge may be contextually appropriate and timely if a nudge to set an AI agent to monitor message usage is presented after detecting a memory usage that satisfies a usage threshold. The nudge component 140 may provide the nudge. The nudge may be designed to guide the user towards a specific action or decision, presented in the form of prompts, suggestions, or alerts.

As shown in FIG. 1B, the contextual nudge foundation framework may include a user profile 145, an AI nudging model 150, and a contextual hierarchy 155. The user profile 145 may include a datastore that stores detailed information about the user. For example, the user profile 145 may store user information (regarding the user) that identifies past behaviors of the user, preferences of the user, and interaction history of the user (e.g., interactions with different types nudges (or user interface elements)), preferences of the user with respect to nudges, among other examples. The user profile 145 may be used to personalize the nudges.

The AI nudging model 150 may utilize artificial intelligence to analyze user data and predict future behaviors, developing personalized nudges based on the analysis. The AI nudging model 150 may include a machine learning model. For example, the AI nudging model 150 may include a large language model. The contextual hierarchy 155 may define context in which nudges are presented, considering factors such as a current task of the user, a location within the application, and historical data. The location within the application may refer to a particular screen of the application, a particular user interface of the application, among other examples.

The contextual nudging system 110 may be used in multiple different scenarios. In one scenario, a first user is a prospective user for a Gen AI platform. The first user is looking for options around what to use for Gen AI as a foundational part of her daily workflow. Based on historical data from like user types, a predictive path is determined by agents and imagery, content, and a call to action is presented to the first user pushing the first user to explore the Gen AI experience. Based on the first user's reaction, feedback is presented back to the agentic model for refinement.

In another scenario, a second user is an experienced, repeat user who wants to maximize his time savings. The second user receives nudges based on priority level that extend to various devices so he is alerted immediately to take action on something urgent. The second user can select the prompt from his phone and goes to the application where the nudge is connected to an agent that can report on the issue and proposes a solution that can be automated. The second user selects for the agent to problem solve and automate like issues for the future giving the second user back time for himself, but speeding up the overall issue resolution process as a result of the agent automation.

The network 160 may encompass a wide range of communication technologies and architectures to facilitate data exchange between the various components of the computing environment. In some implementations, the network 160 may include traditional wired networks, such as Ethernet-based local area networks (LANs) or fiber optic networks for high-speed, long-distance data transmission. These wired networks may provide reliable, high-bandwidth connections suitable for data-intensive error management tasks. Wireless technologies may also be incorporated into the network 160. For instance, Wi-Fi networks may enable flexible connectivity within office environments or data centers, while cellular networks, including 4G LTE or 5G, may support mobile devices or remote sensors in IoT scenarios. In some cases, the network 160 may leverage satellite communication systems to provide connectivity in remote or hard-to-reach locations.

As indicated above, FIGS. 1A and 1B are provided as an example. Other examples may differ from what is described with regard to FIGS. 1A and 1B. The number and arrangement of devices shown in FIGS. 1A and 1B are provided as an example. There may be additional devices (e.g., a large number of devices), fewer devices, different devices, or differently arranged devices than those shown in FIGS. 1A and 1B. Furthermore, two or more devices shown in FIGS. 1A and 1B may be implemented within a single device, or a single device shown in FIGS. 1A and 1B may be implemented as multiple, distributed devices. Additionally, or alternatively, a set of devices (e.g., one or more devices) shown in FIGS. 1A and 1B may perform one or more functions described as being performed by another set of devices shown in FIGS. 1A and 1B.

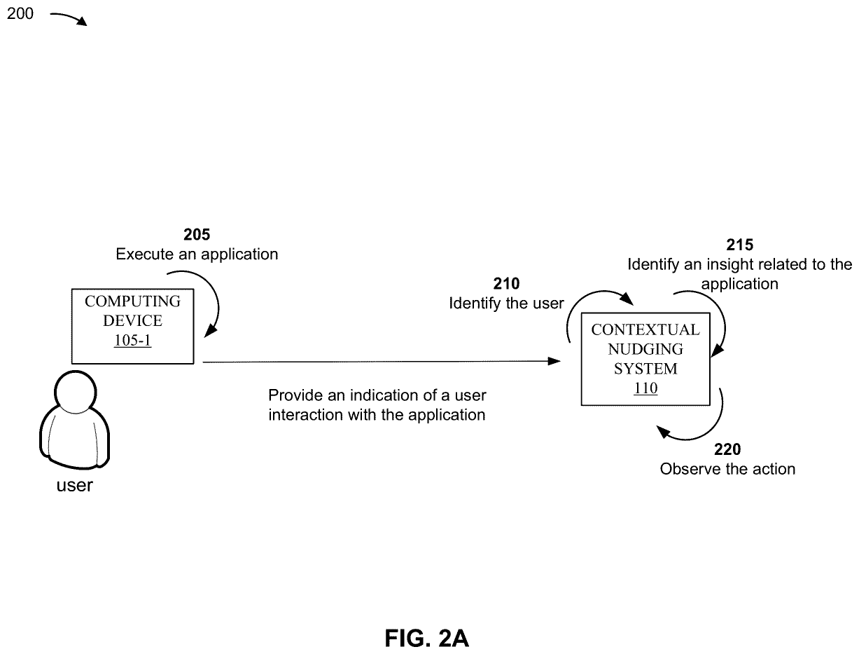

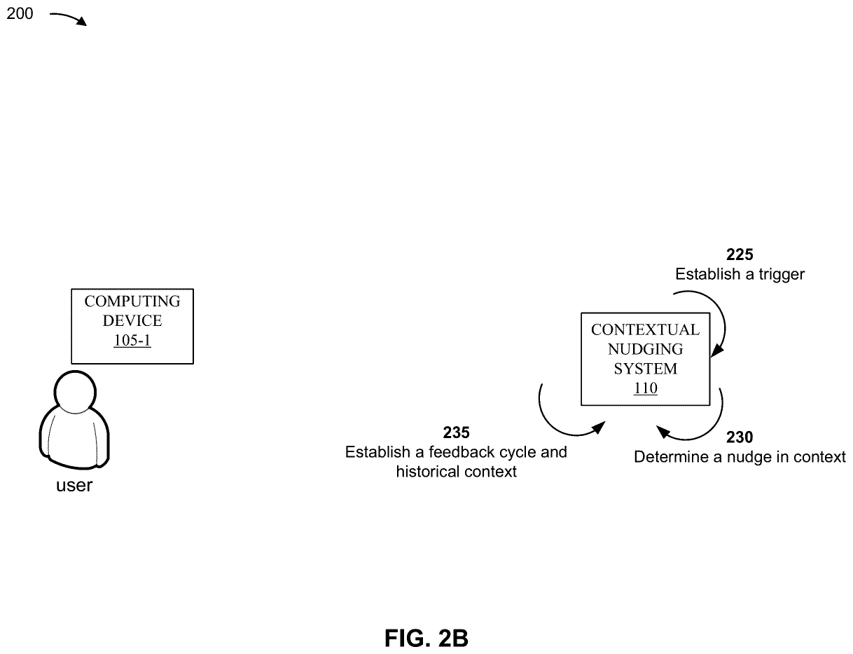

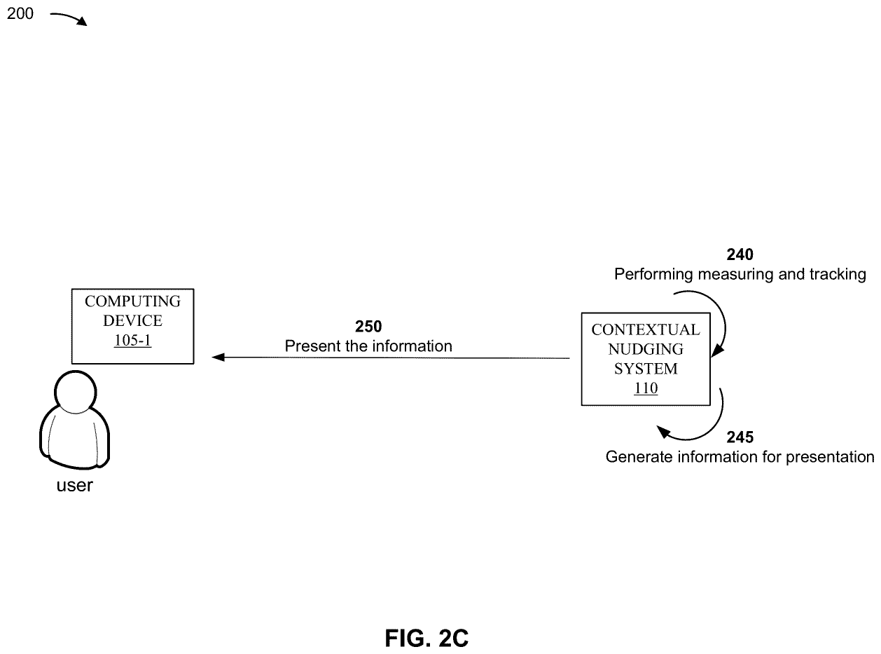

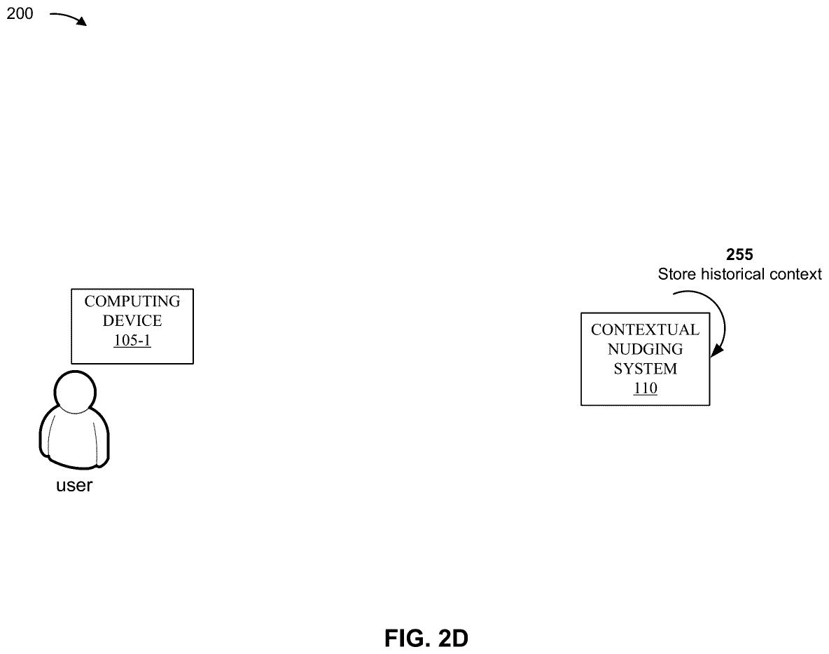

FIGS. 2A-2D are diagrams of an example implementation 200 described herein. As shown in FIGS. 2A-2D, example implementation 200 includes the computing device 105-1 and the contextual nudging system 110. As shown in FIG. 2A, and by reference number 205, the computing device 105-1 may be executing an application. As shown in FIG. 2A, the computing device 105-1 may provide an indication of a user interaction with the application. For example, a user of the computer device 105-1 may be interacting with the application. In some examples, the user may be using an AR experience, a VR experience, among other examples. The computing device 105-1 may provide an indication of a user interaction with the application. The indication may be provided to the contextual nudging system 110. For example, at a predetermined sampling rate that is learned by divergent predictive paths, an agentic architecture may be invoked by the contextual nudging system 110. The agentic architecture may include one or more AI agents. The agentic architecture may provide a request for an application executing on the computing device 105-1 and the computing device 105-1 may provide the indication. The indication may include user information regarding the user.

As shown in FIG. 2A, and by reference number 210, the contextual nudging system 110 may identify the user. In some implementations, the contextual nudging system 110 may identify the user using a user profile (e.g., stored in the user profile 145), using log in information provided when the user accesses the application, and/or using prior session data of a session involving the application. In some examples, a first agent may initialize a state that is shared across all agents of the agentic architecture. In some examples, tools may be called by the contextual nudging system 110. The tools may be implemented by the contextual nudging system 110 and may connect to datastores such as image grabbers, user information, and path flows.

In some examples, as part of identifying the user, the contextual nudging system 110 may identify a user type of the user. The identification of the user type may determine at a meta level the type of content that will be shown with specified insights. The contextual nudging system 110 may identify the user type to ensure the user type aligns with user expectations of what the user needs to see and can do.

As shown in FIG. 2A, and by reference number 215, the contextual nudging system 110 may identify an insight related to an application. In some implementations, the insight identification may be based on the image, user data, and action path predicted by the model to be the most likely for the user to respond to. The insight may be an insight perceived to be of value to the user. For example, the insight may be related to preserving memory usage.

As shown in FIG. 2A, and by reference number 220, the contextual nudging system 110 may observe the action. The contextual nudging system 110 may observe the action performed by the user when using the application. The contextual nudging system 110 may observe the action to predict a most likely action path a user will take while using the application.

As shown in FIG. 2B, and by reference number 225, the contextual nudging system 110 may establish a trigger. For example, the contextual nudging system 110 may establish a trigger for presenting the nudge. Once the predicted model is established by the system, the contextual nudging system 110 (e.g., the one or more tools 115) may use frequentist Bayesian statistics to determine a most likely action path the user will take to a terminal node (e.g., a desired action). For example, the contextual nudging system 110 may predict the most likely action. The contextual nudging system 110 (e.g., the one or more tools 115) may select actions the user has already taken and any corrections thereof.

As shown in FIG. 2B, and by reference number 230, the contextual nudging system 110 may determine a nudge in context. For example, the contextual nudging system 110 (e.g., using the one or more tools 115) may obtain an image of the user interface. The acquisition of an image is a visual frame grabber that takes a picture of the user interface. Content and imagery is presented to the user in the user interface, as part of a call to action to the user. In the other words, the content and imagery may be presented as a nudge to cause the user to perform the action (e.g., a task).

As shown in FIG. 2B, and by reference number 235, the contextual nudging system 110 may establish a feedback cycle and historical context. For example, based on the actions of the user, a feedback loop is introduced to determine the success of the nudge presented to the user and to determine whether the nudge is valid or invalid. The historical content for the nudge is also measured against past cycles and dependencies are noted around the context of the situation, variances, and anomalies. As part establish the feedback, in some situations, an image of the user interface and information regarding the predicted path may be provided to a feedback LLM agent of the contextual nudging system 110. The contextual nudging system 110 may generate a prompt that instructs the LLM agent to generate a summary. The contextual nudging system 110 (e.g., a corrective agent) may ensure an optimal path and the predictive path are represented well by a summarization. The corrective agent searches for keywords and factualness. If the corrective agent detects a faulty output, it circles back to the language tools to begin again.

If the flow passes the corrective agent, the information is sent to a judge agent of the contextual nudging system 110. The judge agent may measure delta scores, explainability, factualness, relevance, and optimality dimensions. The measurements and metrics are combined and sent to a feedback LLM agent.

As shown in FIG. 2C, and by reference number 240, the contextual nudging system 110 may perform measuring and tracking operations. For example, within the feedback LLM agent, the prompt instructs the feedback LLM agent to write a summary about the deficiencies and inefficiencies of the user action by the judge agent. The summary may help to close any alignment problem between what the user is actioning versus what the judge agent measured.

As shown in FIG. 2C, and by reference number 245, the contextual nudging system 110 may generate information for presentation. In some examples, the feedback (or summary) is sent to a visual tool of the contextual nudging system 110 to retrieve images that are related to the feedback. The images may be presented as overlays in the application. The images along with the generation of questions derived from the difference between the predictive path and objective are generated from a LLM. The corrective agent may ensure the questions are related and relevant to the predictive path through prompt engineering.

As shown in FIG. 2C, and by reference number 250, the contextual nudging system 110 may generate information for presentation. For example, the contextual nudging system 110 may generate the nudge based on the images and the questions. In some implementations, the corrective agent inserts the nudging material into the application. The user may view the augmented imagery to guide them towards a desired outcome (e.g., the terminal node). The nudge may include a call to action, content, and imagery. The nudge may be presented as a user interface element in the user interface of the application.

A transform agent of the contextual nudging system 110 may convert the questions and graphics into vector representations that can be used by a diffusion agent. A diffusion agent of the contextual nudging system 110 may receive the output from the transform agent and the image. The diffusion agent may insert information (e.g., material) of the nudge into the user interface. The user can view the augmented imagery to guide them towards a desired outcome.

In some implementations, the contextual nudging system 110 may determine a section of the user interface for nudge. The contextual nudging system 110 may determine the section based on the user information of the user and/or of other users of the same type. The user information may identify interactions of user interface elements and sections of the user interface including the user interface elements. For example, the contextual nudging system 110 may identify one or more sections associated with a number of interactions that satisfy a threshold and may present the user interface element in a section of the one or more sections.

In some examples, the contextual nudging system 110 may identify a type of the user interface element as described herein. In some examples, the contextual nudging system 110 may perform (graphical) operations on the user interface to draw the attention of the user to the user interface element, as described herein.

As shown in FIG. 2D, and by reference number 255, the contextual nudging system 110 may store historical context. In some examples, the contextual nudging system 110 may store detailed information about the user, including past behaviors (e.g., interactions), preferences, and interaction history, to personalize the nudges. The contextual nudging system 110 may continue to analyze user information (regarding one or more users) user data and predict future behaviors, developing a repository of personalized nudges based on this analysis.

Moments that define the context in which nudges are presented, considering factors such as the user's current task, location within the application, and historical data. This is stored within the system and fuels the agents and the resulting nudges that surface to the user.

As indicated above, FIGS. 2A-2D are provided as an example. Other examples may differ from what is described with regard to FIGS. 2A-2D. There may be additional devices (e.g., a large number of devices), fewer devices, different devices, or differently arranged devices than those shown in FIGS. 2A-2D. Furthermore, two or more devices shown in FIGS. 2A-2D may be implemented within a single device, or a single device shown in FIGS. 2A-2D may be implemented as multiple, distributed devices. Additionally, or alternatively, a set of devices (e.g., one or more devices) shown in FIGS. 2A-2D may perform one or more functions described as being performed by another set of devices in FIGS. 2A-2D are.

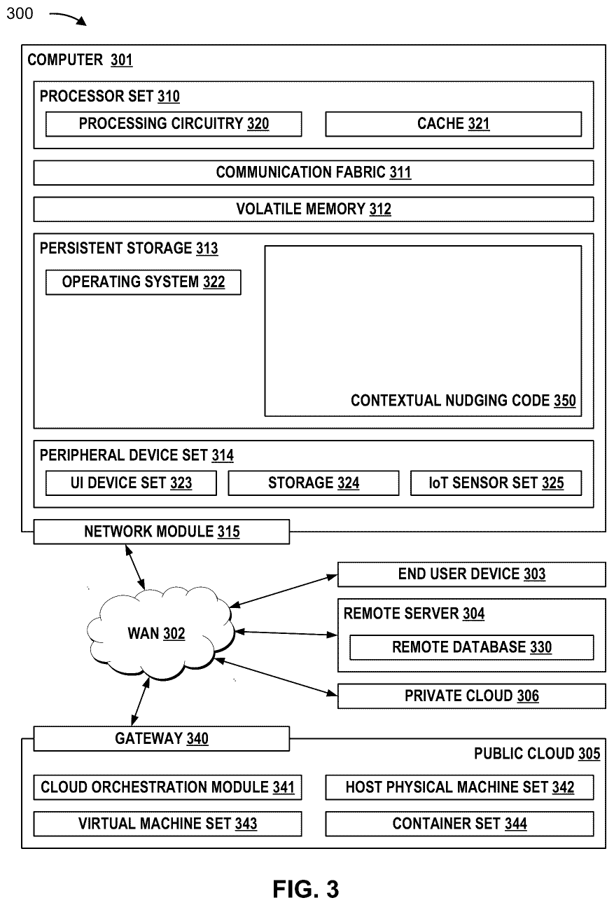

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as a contextual nudge code, shown in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (V CEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

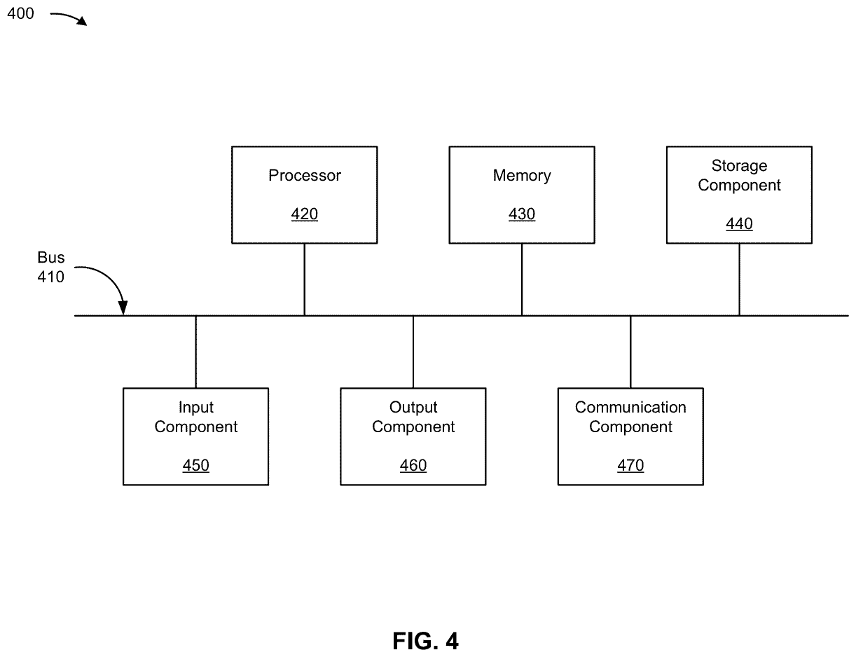

FIG. 4 is a diagram of example components of a device 400, which may implement one or more components of the computing environment 100. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

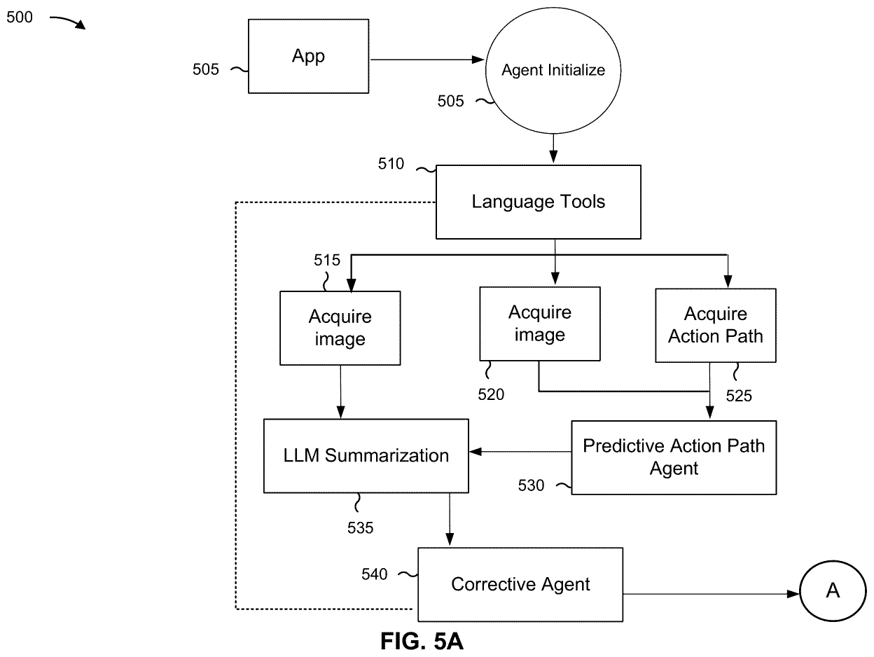

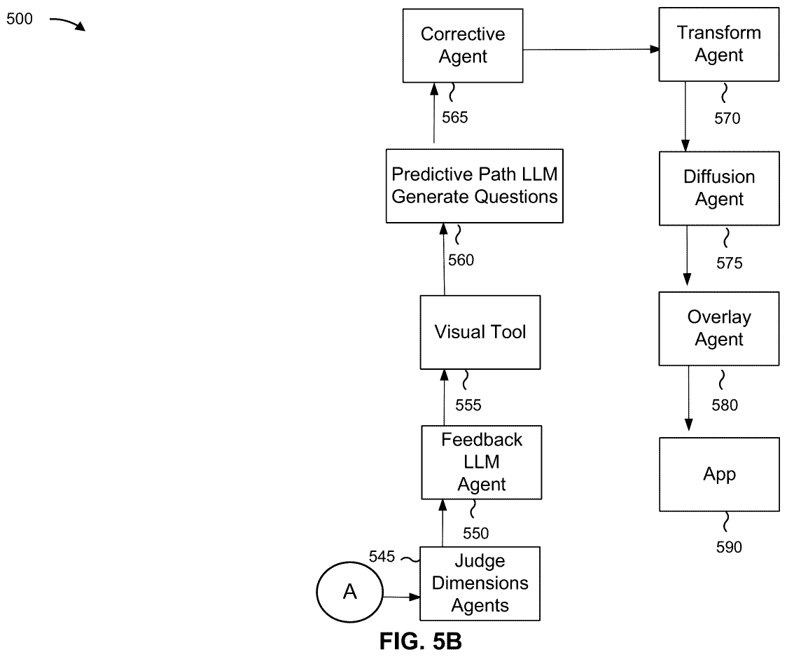

FIGS. 5A and 5B is a flowchart of an example process 500 associated with reducing computer usage. In some implementations, one or more process blocks of FIGS. 5A and 5B may be performed by a contextual nudging system (e.g., the contextual nudging system 110) and a computing device (e.g., the computing device 105). Additionally, or alternatively, one or more process blocks of FIGS. 5A and 5B may be performed by one or more components of device 400, such as processor 420, memory 430, storage component 440, input component 450, output component 460, and/or communication component 470.

As shown in FIGS. 5A and 5B, a user or actor can be using any application, VR, or AR experience. At a predetermined sampling rate that is learned by divergent predictive paths, an agentic architecture is invoked. The first agent initializes state that is shared across all agents (block 510).

Next, tools are called (block 510). These tools connect to datastores such as image grabbers, user information, and path flows. The acquisition of an image is a visual frame grabber that takes a picture of the interface (block 515). The user data piece selects actions the user has already taken and any corrections thereof (block 520). The acquire action path uses frequentist Bayesian statistics to determine the most likely action path the user will take to a terminal node (block 525).

The predictive action path agent uses both the user data and statistical data to predict a path the user will take (block 530). That information is sent to an LLM Summarization agent along with the image that was acquired (block 535). The small vision model along with an LLM is able to extract information from the image and the predictive path to make suggestions on how the user can create an optimal path. The differences between the optimal path and predictive are summarized.

Next, a correct agent ensures the optimal path and predictive path are represented well by the summarization (block 540). The agent searches for keywords and factualness. If the corrective agent detects a faulty output, it circles back to the language tools to begin again. If the flow passes the corrective agent, the information is sent to a judge. Here the judge measures delta scores, explainability, factualness, relevance, and optimality dimensions (block 545). The measurements and metrics are combined together and sent to a Feedback LLM A gent (block 550).

Within the feedback LLM, a prompt that instructs the agent to write a summary about the deficiencies and inefficiencies of the user action given the judge dimensions. This helps to close the alignment problem between what the user is actioning versus what the judge measured.

The feedback is sent to a visual tool to retrieve images that are related to the feedback. The images are intended to eventually become overlays into the app (block 555). The images along with the generation of questions derived from the difference between the predictive path and objective are generated from a LLM (block 560). A corrective agent ensures the questions are related and relevant to the predictive path through prompt engineering (block 565).

Next, a transform agent converts the questions and graphics into vector representations that can be used by a diffusion agent (block 570). The diffusion agent receives the output from the transform agent and the app image (block 575). The overlay agent inserts the nudging material into the application (e.g., a user interface) (block 580). The user can view the augmented imagery to guide them towards a desired outcome (block 590).

In some situations, with respect to the alignment, during the creation of text, human editors work with the output of generative AI system, genAI(gllm, xᵢ), that encompasses a set of, j, large language models, llm, with input prompt, xᵢ.

gllm={∀llmⱼ} (1)

The initial output, o_{i,k}, from sample i of the llm pipeline is edited by a human editor, hₖ∈H, that is drawn from a set of human editors, H.

o_{i,k}=hₖ(genAI(gllm,xᵢ)) (2)

Equation 2 depicts the results of generative text edits that will be judged by a generative pipeline, jllm. The vector [symbol] contains the set of orthogonal dimensions, dᵢ, that measures the confidence level that a property exists.

[symbol]

=genAI(jllm,o_{j,k}) (3)

Now, each of the dimensions, dᵢ, is within the space [symbol] ^{|d|} such that a square matrix, ek with shape |d|×|d|, represents a human editor's k corrected expectations over all m points. To maintain orthogonality, a singular row, m, within e_{i,m}_{ₖ} lies on a singular dimension, n, such that all other dimensions are 0. However, to calculate covariance scaling, a raw matrix, eraw_{i,m}_{_{k′}} does not reduce all other dimensions to 0 to maintain orthogonality.

$${e}_{i , {m}_{k}} = {[ \begin{matrix}{d}_{i , m} & … & {d}_{i + y , m} \\ ⋮ & {d}_{i + 1 , m + 1} & ⋮ \\ {d}_{i , m + y} & … & {d}_{i + y , m + y}\end{matrix} ]}_{k} \qquad ( 4 )$$

cos(dₘ*∀dₙ)=0∴m≠n (5)

A scaled covariance matrix in equation x, cov_{i,m}_{ₖ}, between all combinations of dimensions, dᵢ, in eraw_{i,m}_{ₖ} determines the degree of relationships between dimensions.

$$s {cov}_{i , {m}_{k}} = {[ \begin{matrix}1 - \vert cov ( {d}_{i , m} , {d}_{i , m} ) \vert & \cdot & 1 - \vert cov ( {d}_{i + y , m} , {d}_{i , m} ) \vert \\ ⋮ & \cdot & ⋮ \\ 1 - \vert cov ( {d}_{i + y , m} , {d}_{i , m} ) \vert & \cdot & 1 - \vert cov ( {d}_{i + y , m + y} , {d}_{i + y , m + y} ) \vert\end{matrix} ]}_{k} \qquad ( 6 )$$

The relationship between e_{i,m}_{ₖ} and eraw_{i,m}_{ₖ} will be through a lookup of the paired dimension scov_{i,m}_{ₖ} value. A mapping function will take the maximum 1−|cov(d_{i,m},d_{j,m})| across a column in scov_{i,m}_{_{k′}} The value of the corresponding e_{i,m}_{ₖ} is the weighted edge between (d_{i,m}, d_{j,m}). Equation 7 shows a graph representation, G(E, V), that takes the form of a polygon with edges E and vertices V.

G(E,V)ₖ;E=1−|cov(d_{i,m},d_{i,m})|;V=e_{rows}_{ₖ} (7)

Now, a second set of generated output, oᵢ, without human correction that has been judged by a LLM pipeline, jllm, is prepared to create another polygon following equations 4, 6, 7.

oᵢ=genAI(llm,xᵢ) (8)

\vec{J₁}=genAI(jllm,oᵢ) (9)

Two graphs from the same input samples, xᵢ, can be compared with that the Theory of Mind of area, tmaₖ, and the Theory of Mind distance, tmdₖ. Equation 11 shows the differences between the areas of the polygons, G and Gₖ, by taking the determinant of the |d|×|d| matrices created by the transformation function f. The tmdₖ is computed as the cartesian distance between all coordinate nodes depicted in equation 12.

visualize(G(E,V)ₖ,G(E,V)) (10)

tmaₖ=det(f(G(E,V)ₖ))−det(f(G(E,V)))| (11)

tmdₖ={square root over ((G(E,V)ₖ−G(E,V))²)} (12)

In the case of rectangular matrices of the graphs G and Gₖ, the Hausdorff measure can compute partial areas of the polygon. As shown in equation 13, for each dimension, dᵢ, is a Hausdorff dimension that can be used to compute the size of each shape within a rectangular matrix.

$${Area}_{k} \approx \frac{1}{{2}^{( \vert d \vert - 1 )}} * ( {volume}_{1} + … + {volume}_{d} ) \qquad ( 13 )$$

More generally, each matrix can be factored into multiple square matrices, e_{i,m}_{_{k′}} such that volumes of subspaces can be calculated.

volumeₖ=∫∫ . . . ∫|det(e_{i,m}_{_{k′}})dx₁dx₂dx₃. . . dxₖ (14)

After the Areaₖ and original Area is known, equations 15 computes the user's theory of mind, tmaₖ.

tmaₖ=|Areaₖ−Area| (15)

Several parameters influence the output of an LLM. For example, each LLM prompt, xᵢ, contains an instruction, i_{z}, and an optional context, c_{z}. The instruction, i_{z}, tells the model a particular behavior to follow that establishes task following. Another parameter is called the temperature, t. Equation 16 shows the importance of temperature by scaling the probabilities assigned to each candidate word, p_{w}, where n is the size of the library and y is a candidate word. The smaller the temperature, the more confident a model is assigning probabilities to words.

$${p}_{w} = \frac{{e}^{\frac{{y}_{i}}{t}}}{{\sum }_{k = 1}^{n} {e}^{\frac{{y}_{k}}{t}}} \qquad ( 16 )$$

Another parameter is called the top-p, tp, which filters out words that fall below a cumulative distribution of the most probable words. Whereas the top-k, tk, considers only the kth highest probable words. Equation 17 shows the definition of the Theory of the Mind, tom, as related to tmaₖ and tmdₖ is 0.

$$tom = \{ \begin{matrix}true : {tma}_{k} = 0 and {tmd}_{k} = 0 \\ false : otherwise\end{matrix} \} \qquad ( 17 )$$

The optimization problem of Theory of the Mind is established by equation 18. Stochastic gradient descent steps from equation 19 and 20 with an instruction, i_{z}, held constant will continue until convergence. Next, another instruction, i_{z}, will go through the same process until the best combination of i_{z}, tp, and tk satisfy a maximization of equation 18. The empirical risk, Q, is an estimation of the probability of obtaining a tmaₖ_{ₜ} or tmdₖ_{ₜ} value at step, t.

Pₜₒₘ(tom=true|i_{z},tp,tk)=(tom=true|tmaₖ(i_{z},tp,tk),tmdₖ(i_{z},tp,tk)) (18)

tmaₖ_{ₜ₊₁}=tmaₖ_{ₜ}−ηΔQ(tmaₖ_{ₜ}) (19)

tmdₖ_{ₜ₊₁}=tmdₖ_{ₜ}−ηΔQ(tmdₖ_{ₜ}) (20)

Although FIGS. 5A and 5B show example blocks of process 500, in some implementations, process 500 may include additional blocks, fewer blocks, different blocks, or differently arranged blocks than those depicted in FIGS. 5A and 5B. Additionally, or alternatively, two or more of the blocks of process 500 may be performed in parallel.

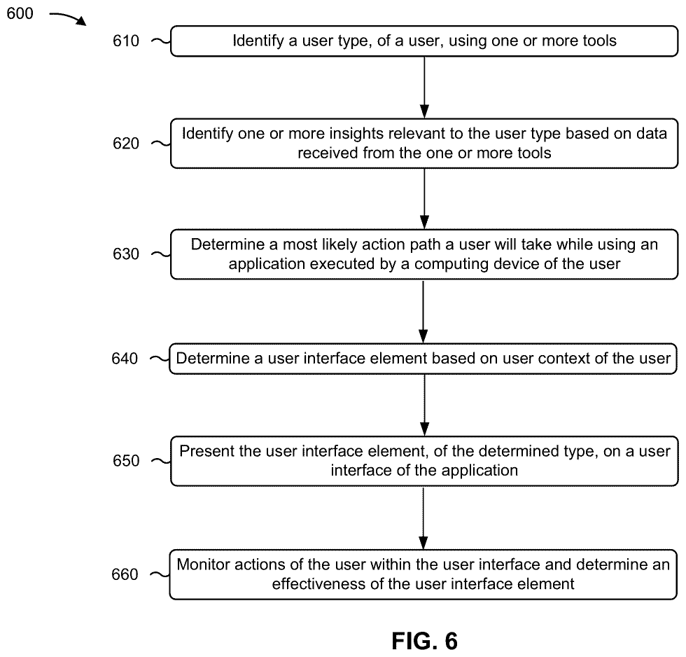

FIG. 6 is a flowchart of an example process 600 associated with reducing computer usage. In some implementations, one or more process blocks of FIG. 6 may be performed by an contextual nudge system (e.g., the cc) and a computing device (e.g., the computing device 105). Additionally, or alternatively, one or more process blocks of FIG. 6 may be performed by one or more components of device 400, such as processor 420, memory 430, storage component 440, input component 450, output component 460, and/or communication component 470.

As shown in FIG. 6, process 600 may include identifying a user type, of a user, using one or more tools (block 610).

As shown in FIG. 6, process 600 may include identifying one or more insights relevant to the user type based on data received from the one or more tools (block 620).

As shown in FIG. 6, process 600 may include determining a most likely action path a user will take while using an application executed by a computing device of the user (at block 630).

As shown in FIG. 6, process 600 may include determining a user interface element based on user context of the user (at block 640).

As shown in FIG. 6, process 600 may include presenting the user interface element, of the determined type, on a user interface of the application (at block 650).

As shown in FIG. 6, process 600 may include monitoring actions of the user within the user interface and determine an effectiveness of the user interface element (at block 660).

As shown in FIG. 6, process 600 may include updating the agent policy based on the key metrics and/or the revised key metrics (at block 570).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The descriptions of the various embodiments of the present invention have been presented for purposes of illustration, but are not intended to be exhaustive or limited to the embodiments disclosed. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for contextual nudging, the computer-implemented method comprising:
identifying a user type of a user using one or more tools, wherein the one or more tools are connected to datastores;
identifying one or more insights relevant to the user type based on data received from the one or more tools, wherein the data is obtained by the one or more tools from the datastores;
determining a most likely action path the user will take using Bayesian statistics, wherein the most likely action path is determined based on the data;
determining a nudge based on user context, wherein the user context is based on the data;
determining a section, on a user interface provided by a computing device, for presenting the nudge, wherein the section is determined based on the most likely action path and the user context;
presenting the nudge in the section of the user interface; and
monitoring actions of the user within the user interface and determining an effectiveness of the nudge.

2. The computer-implemented method of claim 1, further comprising:
sending feedback to a large language model (LLM) agent based on the actions of the user; and
generating a prompt, wherein the prompt instructs the LLM agent to generate a summary of the actions.

3. The computer-implemented method of claim 1, where the user interface is a user interface of an application further comprising:
obtaining an image of the user interface, wherein the image is included in the data obtained by the one or more tools, wherein the image indicates at least one of a location within the application or a current task being performed using the application, and wherein the user context includes at least one of information regarding the location or information regarding the current task.

4. The computer-implemented method of claim 1, further comprising:
determining a score regarding a task performed using the user interface,
wherein the score indicates a measure of completion of the task, an amount of time to perform the task, a measure of success in performing the task.

5. The computer-implemented method of claim 1, further comprising:
determining a measure of receptivity, of the user, to a type of the nudge; and
determining the nudge further based on the measure of receptivity.

6. The computer-implemented method of claim 1, wherein the nudge is a first nudge, the method further comprising:
determining a measure of receptivity, of the user, to a first type of the first nudge after the first nudge has been presented;
determining a second nudge of a second type further based on the measure of receptivity to the first type; and
presenting the second nudge.

7. The computer-implemented method of claim 1, further comprising:
determining a type of nudges to present based on user data of the user,
wherein the user data is included in the data obtained by the one or more tools, and
wherein the user context includes the user data; and
determining the nudge based on the type of nudges.

8. A computer program product comprising:
one or more computer-readable storage media; and
program instructions stored on the one or more computer readable storage media to perform operations comprising:
identifying a user type, of a user, using one or more tools;
identifying one or more insights relevant to the user type based on data received from the one or more tools, wherein the data is obtained by the one or more tools from datastores;
determining a most likely action path a user will take while using an application executed by a computing device of the user, wherein the most likely action path is determined using user data included in the data and statistical data, and wherein the user data indicates actions that have been performed by the user using the application;
determining a user interface element based on user context of the user, wherein the user interface element provides information regarding the one or more insights, and wherein the user context is based on the data;
determining a type of the user interface element based on the user data, wherein the user data indicates actions performed by the user with respect to one or more types of user interface elements; and
presenting the user interface element, of the determined type, on a user interface of the application.

9. The computer program product of claim 8, wherein presenting the user interface element comprises:
presenting the user interface element to the computing device; and
presenting the user interface element to another computing device of the user.

10. The computer program product of claim 8, wherein the operations further comprise:
determining priorities of a plurality of tasks, of the application, to be performed by the user,
wherein the user interface element is associated with a task of the plurality of tasks; and
presenting the user interface element based on a priority of the task.

11. The computer program product of claim 10, wherein the operations further comprise:
determining a score regarding the task performed using the user interface, wherein the score indicates a measure of completion of the task, an amount of time to perform the task, a measure of success in performing the task.

12. The computer program product of claim 11, wherein the operations further comprise:
determining an intelligent workflow for completing the plurality of tasks; and
presenting the user interface element as part of the intelligent workflow.

13. The computer program product of claim 8, wherein performing the action comprises:
monitoring one or more actions of the user within the user interface;
sending feedback to a large language model (LLM) agent based on the one or more actions of the user; and
generating a prompt, wherein the prompt instructs the LLM agent to generate a summary of the one or more actions.

14. The computer program product of claim 8, wherein the operations further comprise:
obtaining an image of the user interface, wherein the image is included in the data obtained by the one or more tools, wherein the image indicates at least one of a location within the application or a current task being performed using the application, and wherein the user context includes at least one of information regarding the location or information regarding the current task.

15. The computer program product of claim 8, wherein the operations further comprise:
determining a section, on the user interface, for presenting the user interface element, wherein the section is determined based on the most likely action path and the user context; and
presenting the user interface element in the section of the user interface.

16. A computer system comprising:
one or more computer-readable storage media;
a processor set; and
program instructions stored on the one or more computer-readable storage media to cause the processor set to perform operations comprising:
identifying a user type, of a user, using one or more tools;
identifying one or more insights relevant to the user type based on data received from the one or more tools, wherein the data is obtained by the one or more tools from datastores;
determining a most likely action path a user will take while using an application executed by a computing device of the user, wherein the most likely action path is determined using user data included in the data and statistical data, and wherein the user data indicates actions that have been performed by the user using the application;
determining a user interface element based on user context of the user, wherein the user interface element provides information regarding the one or more insights, and wherein the user context is based on the data;
determining a type of the user interface element based on the user data, wherein the user data indicates actions performed by the user with respect to one or more types of user interface elements; and
presenting the user interface element, of the determined type, on a user interface of the application.

17. The computer system of claim 16, wherein the user type is based on a level of experience with respect to using the application.

18. The computer system of claim 16, wherein the operations further comprise:
determining a section, on the user interface, for presenting the user interface element, wherein the section is determined based on the most likely action path and the user context; and
presenting the user interface element in the section of the user interface.

19. The computer system of claim 16, wherein the operations further comprise:
determining priorities of a plurality of tasks, of the application, to be performed by the user,
wherein the user interface element is associated with a task of the plurality of tasks; and
presenting the user interface element based on a priority of the task.

20. The computer system of claim 19, wherein the operations further comprise:
determining a score regarding the task performed using the user interface,
wherein the score indicates a measure of completion of the task, an amount of time to perform the task, a measure of success in performing the task.
